(19) United States
(12) Patent Application Publication
(10) Pub. No.: US 2007/0214719 A1
(43) Pub. Date: Sep. 20, 2007

(54) Solid-Fuel Gasification System

(76) Inventor: Kunio Yoshikawa, Sagamihara-shi (JP)

Correspondence Address: JACOBSON HOLMAN PLLC, 400 SEVENTH STREET N.W., SUITE 600, WASHINGTON, DC, 20004, US

(21) Appl. No.: 11/628,002

(22) PCT Filed: Jun. 1, 2004
(86) PCT No.: PCT/JP04/07888

§ 371 Date: Nov. 30, 2006

(51) Int. Cl. B01J 7/00

(52) U.S. Cl. 48/61

(57) ABSTRACT

A solid fuel gasification system of the present invention enables omission of the char recycling means and enables production of syngas having a high calorific value and containing hydrogen and carbon monoxide as its main components. The gasification system has a pyrolysis area isolated from supply of air; a char combustion area producing a high temperature combustion gas by combustion of char of the pyrolysis area; a dust remover cleaning the combustion gas; combustion means for reheating the cleaned combustion gas to raise its temperature; and a steam heater for heating steam up to a high temperature by heat exchange between the combustion gas and the steam. The gasification system pyrolyzes the solid fuel with use of the high temperature steam so that syngas is produced, which contains hydrogen and carbon monoxide as its main components.

### TECHNICAL FIELD

The present invention relates to a solid fuel gasification system, and more specifically, to such a system for producing a syngas containing hydrogen and carbon monoxide as its main components by pyrolytic decomposition of a solid fuel.

### TECHNICAL BACKGROUND

A solid-fuel gasification system is known in the art, which gasifies organic waste such as waste plastic, sludge, shredder dust or municipal refuse, or a low quality solid fuel such as coal, and which feeds a relatively high calorie syngas to an electric power generator or the like. This inventor has developed this kind of fuel gasification system which gasifies and melts the solid fuel with use of high temperature air at approximately 1,000° C., and has proposed it in Japanese patent application laid-open publication No. 2000-158885 (JP 2000-158885).

This type of gasification system has a gasifier for gasifying and melting the solid fuel, as shown in FIGS. 10 and 11. An air heater feeds high temperature air at a temperature above 1,000° C. to the gasifier. A heat recovery and gas purification device cools and purifies a crude gas of the gasifier. The solid fuel fed to the gasifier is molten by the high temperature air, and generates the high temperature crude gas at approximately 1,000° C. The high temperature crude gas is fed to the heat recovery and gas purification device, which cools and purifies the gas, and then, feeds the purified gas to an electric power generator and so forth. Char (carbide remaining after pyrolytic decomposition) recovered by the heat recovery and gas purification device is introduced into a solid fuel supply passage by char recycling means, and the char is fed to the gasifier together with the solid fuel. A part of the purified gas is fed to the air heater as a fuel for heating air. The ,air heater heats the air with the heat of combustion of the purified gas and feeds the high temperature air to the gasifier. According to such a gasification system, the crude gas has an extremely high temperature (approximately 1,000° C.). Therefore, a tar content of the crude gas is decreased, and a relatively large quantity of hydrogen is contained in the gas.

This inventor has also developed a fuel gasification system in which a pyrolysis gas produced by pyrolytic decomposition of a solid fuel is reformed by high temperature steam. The reformed gas is fed to an electric power generator or the like. This system has been proposed in Japanese patent application laid-open publication No. 2002-210444 (JP2002-210444) and so forth.

This type of gasification system has a pyrolyzer for pyrolytic decomposition of the solid fuel and a reformer for reforming a pyrolysis gas by the high temperature steam, as shown in FIGS. 12 and 13. The solid fuel fed to the pyrolyzer is pyrolyzed therein, and the pyrolysis gas at approximately 300° C. is produced in the pyrolyzer and fed to the reformer. The pyrolysis gas mixes with the high temperature steam at approximately 1,000° C. in the reformer to be reformed therein. A temperature drop of the furnace temperature occurs in the reformer, owing to a steam reforming reaction (endothermic reaction) of hydrocarbon in the pyrolysis gas. In order to prevent this temperature drop, the high temperature air at approximately 1,000° C. is fed to the reformer. A reformed gas at approximately 800° C. is fed from the reformer to a heat recovery and gas purification device, which cools and purifies the reformed gas and which feeds purified gas to an electric power generator or the like. A part of the purified gas is fed to an air/steam heater, which heats air and steam by heat of combustion of the purified gas. The heater feeds high temperature air and steam at approximately 1,000° C. to the reformer.

In such types of gasification systems, the solid fuel stays in the pyrolyizer for a relatively long time, and therefore, waste or the like being of a relatively large size can be pyrolyzed. Further, a high rate of carbon conversion is attained and production of soot is restricted. Therefore, it is possible to omit provision of the char recycling means. Furthermore, in a case where an ash melting combustor is additionally incorporated into the system, this system can have the advantage of extraction of molten ash without char content.

In a gasification system provided with the aforementioned gasification and melting type of gasifier (FIGS. 10 and 11), a relatively large amount of soot tends to be contained in the fuel gas, and production of the soot is significant in the case of gasification of the solid fuel, especially waste plastic or the like. Therefore, this system requires provision of char recycling means for recycling char. Further, this system encounters difficulty of gasification of waste or the like having relatively large sizes, since the residence time of the solid fuel in the gasifier is a relatively short time. Therefore, a pre-treatment process and a pretreatment facility for crushing the solid fuel are required. Furthermore, the calorific value of the purified gas is about 1,000 kcal/Nm³ in this type of gasification system and therefore, the obtained syngas merely has a low calorific value.

On the other hand, the gasification system provided with the pyrolyzer and the reformer (FIGS. 12 and 13) enables omission of the char recycling means, and enables pyrolytic decomposition of the solid fuel having a relatively large size, without crushing of the solid fuel. However, for substantially complete reforming of the tar component contained in the pyrolysis gas, a relatively large amount of high temperature air is fed to the reformer so as to keep the furnace temperature of the reformer in a considerably high temperature (approximately 1,000° C.). As the result, a calorific value of the reformed gas after the reforming and purification processes is decreased down to approximately 1,000 kcal/Nm³. Further, the purified gas contains a relatively large quantity of methane in this type of system, but it is difficult to produce a syngas containing a large quantity of hydrogen. Thus, improvement of the gasification system for producing a syngas containing a large quantity of hydrogen is desired.

An object of the present invention is to provide a solid fuel gasification system which enables omission of the char recycling means and which enables production of a syngas having a high calorific value and containing hydrogen and carbon monoxide as its main components.

### DISCLOSURE OF THE INVENTION

This inventor has focused on the fact that a large quantity of nitrogen is contained in the aforementioned crude gas or reformed gas in the conventional gasification system, and has studied a gasification system for producing a syngas in which content of nitrogen is reduced. As the result, this inventor has found that a pyrolysis gas containing a relatively large quantity of hydrogen can be produced by pyrolysis of the solid fuel in which only high temperature steam having a temperature equal to or higher than 600° C. is supplied to the pyrolytic gasifier. Thus, the inventor has attained this invention, based on such finding.

The present invention provides a solid fuel gasification system pyrolyzing a solid fuel to produce a syngas containing hydrogen and carbon monoxide as its main components, comprising:

a pyrolysis area isolated from supply of air;

a char combustion area producing a combustion gas by combustion of char of said pyrolysis area in existence of combustion air;

a steam heater heating steam by heat exchange between the combustion gas and the steam;

a dust remover which cleans the combustion gas of the char combustion area between the char combustion area and said steam heater; and

combustion means for reheating the combustion gas, which causes combustion of the cleaned combustion gas delivered from the dust remover to the steam heater for raising temperature of the cleaned combustion gas,

wherein said steam heater is provided with a heat-exchanger, which heats said steam to be high temperature steam having a temperature equal to or higher than 600° C. by means of the heat exchange between the combustion gas and the steam, and wherein the high temperature steam thus heated is fed to said pyrolysis area to cause pyrolytic decomposition of the solid fuel in the pyrolysis area for producing the pyrolysis gas therein.

According to the above arrangement of the present invention, the system heats the steam up to a temperature equal to or higher than 600° C. by heat of combustion of the char (a heat source), and the pyrolytic decomposition of the solid fuel is caused by the high temperature steam having a temperature equal to or higher than 600° C. The pyrolysis area isolated from supply of air is substantially closed, except for a solid fuel feeding portion. A heat source fluid to be fed to the pyrolysis area essentially consists of the steam, or the steam occupies 100% of the component of the fluid. A pyrolysis gas, which does not contain nitrogen, is produced in the pyrolysis area, and also, production of soot is restricted. The char residue remaining in the pyrolysis area is incinerated in the char combustor. The heat generated by combustion of the char is supplied to a heat-exchanger for heating the steam, wherein combustion gas produced by combustion of the char acts as heating medium and wherein the combustion gas is effectively used as a heat source for heating the steam. The combustion gas of the char combustion area is fed to the heat-exchanger through the dust remover and therefore, the temperature of the combustion gas is restricted to a temperature equal to or lower than 800° C. (the upper limit of temperature allowed for cleaning parts of the dust remover) . However, the combustion gas subjected to a cleaning step at the dust remover is successively subjected to secondary combustion or re-combustion in the combustion means for reheating the combustion gas, so that the temperature of the gas is raised. The combustion gas raised in its temperature heats the steam up to a high temperature in the steam heater, and the high temperature steam is fed to the pyrolysis area as previously described. The pyrolysis gas produced in the pyrolysis area is reformed by the high temperature steam, so that the syngas is produced, which contains hydrogen and carbon monoxide as its main components and which has a relatively high calorific value.

Thus, the char recycling means can be omitted, since the char is incinerated in the char combustion area in accordance with the present invention. The high temperature steam heated by combustion of the char (a thermal energy source) is fed to the pyrolysis area isolated from supply of air. The pyrolysis gas, which does not contain nitrogen, is produced in the pyrolysis area, since pyrolytic decomposition of the solid fuel is caused solely by the high temperature steam. Further, the pyrolysis gas is reformed by the high temperature steam. Thus, the solid fuel gasisfication system can produce the syngas which contains hydrogen and carbon monoxide as its main components and which has a relatively high calorific value, and the syngas can be fed to an electric power generator, a hydrogen production facility and so forth.

The present invention also provides a solid fuel gasification system pyrolyzing a solid fuel which produces little char residue after pyrolytic decomposition, and producing a syngas which contains hydrogen and carbon monoxide as its main components, comprising:

a pyrolysis area isolated from supply of air;

a combustion means for generating a combustion gas having a temperature exceeding 1,000° C. by combustion of the pyrolysis gas which is produced by the pyrolytic decomposition of the solid fuel in the pyrolysis area, or combustion of a purified gas which is obtained from reforming of said pyrolysis gas; and

a steam heater heating steam by heat exchange between said combustion gas and the steam;

wherein said steam heater is provided with a heat-exchanger which heats said steam to be high temperature steam having a temperature equal to or higher than 600° C. by means of the heat exchange between the combustion gas and the steam, and wherein the high temperature steam is fed to said pyrolysis area to cause pyrolytic decomposition of the solid fuel in the pyrolysis area for producing the pyrolysis gas therein.

According to this arrangement of the present invention, combustion of the pyrolysis gas of the pyrolysis area or combustion of the purified gas obtained after purification of the pyrolysis gas is caused by the combustion means, so that the high temperature combustion gas is produced. The combustion gas generated by combustion of the pyrolysis gas or the purified gas can be directly introduced into the heat-exchanger of the steam heater without taking a cleaning step. Therefore, the temperature of the combustion gas can be set to be a temperature exceeding 1,000° C. Only high temperature steam at a temperature equal to or higher than 600° C. is introduced into the pyrolysis area isolated from supply of air. As the result, the pyrolysis gas, which does not contain nitrogen and which contains a relatively large quantity of hydrogen, is produced in the pyrolysis area, and also, production of soot therein is restricted. The pyrolysis gas produced in the pyrolysis area is reformed by the high temperature steam, and the syngas is produced, which contains hydrogen and carbon monoxide as its main components and which has a relatively high calorific value. Such an arrangement is applied to a gasification system which uses a solid fuel producing little char residue after combustion, such as a biomass fuel.

Thus, the gasification system according to the present invention pyrolyzes the solid fuel, which produces little char residue after combustion, with use of the only high temperature steam. The system generates the combustion gas at a temperature exceeding 1,000° C. by combustion of the pyrolysis gas or purified gas. The combustion gas exchanges heat with the steam for heating the steam up to a temperature equal to or higher than 600° C. Since the solid fuel is pyrolyzed only by the high temperature steam, the pyrolysis gas without content of nitrogen is produced in the pyrolysis area. Further, the pyrolysis gas is reformed by the high temperature steam. Therefore, the system can produce the syngas which contains hydrogen and carbon monoxide as its main components and which has a relatively high calorific value. The syngas can be fed to an electric power generator, a hydrogen production facility and so forth.

### BRIEF DESCRIPTION OF THE DRAWINGS

FIG. 1 is a block flow diagram generally showing an arrangement of a solid fuel gasification system which is a first embodiment of the present invention;

FIG. 2 is a block flow diagram showing an arrangement of a heat source section of the gasification system as shown in FIG. 1;

FIG. 3 is a system schematic diagram illustrating the heat source section of the gasification system as shown in FIG. 1;

FIG. 4 is a block flow diagram generally showing an arrangement of a solid fuel gasification system which is a second embodiment of the present invention;

FIG. 5 is a block flow diagram showing an arrangement of a heat source section of the gasification system as shown in FIG. 4;

FIG. 6 is a system schematic diagram showing the heat source section of the gasification system as shown in FIG. 4, in which a mode of operation in a first step of first and second furnaces is illustrated;

FIG. 7 is a system schematic diagram showing the heat source section of the gasification system as shown in FIG. 4, in which a mode of operation in a second step of the first and second furnaces is illustrated;

FIG. 8 is a block flow diagram showing an arrangement of a gasification system which is a third embodiment of the present invention;

FIG. 9 is a system schematic diagram showing an arrangement of a heat source section of the gasification system as shown in FIG. 8;

FIG. 10 is a block flow diagram generally showing an arrangement of a conventional fuel gasification system, in which a solid fuel is gasified by a gasification melting furnace;

FIG. 11 is a block flow diagram illustrating an arrangement of a heat source section of the gasification system as shown in FIG. 10;

FIG. 12 is a block flow diagram generally showing a conventional fuel gasification system, in which a solid fuel is pyrolytically decomposed in a pyrolyzer and a pyrolysis gas is reformed in a reformer; and

FIG. 13 is a block flow diagram illustrating an arrangement of a heat source section of the gasification system as shown in FIG. 10.

### BEST MODE FOR CARRYING OUT THE INVENTION

In a preferred embodiment of the present invention, the char combustion area is provided within a char combustor. The char residue remaining in the pyrolysis area is introduced into the char combustion area, and combustion air for incineration of the char is fed to the char combustion area.

In another preferred embodiment of the present invention, each of the first and second furnaces is used both for pyrolysis and combustion of the char. Each of the furnaces is provided with an in-furnace area which acts both as a pyrolysis area and a combustion area. A change-over means is provided, for switching operation of the furnaces. The change-over means are alternately changed over to either of the first and second positions, the first position being a position for feeding the high temperature steam to the first furnace and feeding the combustion air to the second furnace, and the second position being a position for feeding the combustion air to the first furnace and feeding the high temperature steam to the second furnace. In the first position, the in-furnace area of the first furnace acts as the pyrolysis area and the in-furnace area of the second furnace acts as the char combustion area. In the second position, the in-furnace area of the first furnace acts as the char combustion area and the in-furnace area of the second furnace acts as the pyrolysis area. According to such an arrangement, combustion of the char, which remains on the furnace bed portion after pyrolytic decomposition of the solid fuel, is caused by the successive introduction of combustion air into the furnace, so that combustion gas is produced. Therefore, provision of a char combustor peculiar to combustion of the char is not required, and provision of a char feeding passage for transferring the char from the first and second furnaces to the char combustor can be also omitted. Each of the first and second furnaces may be a batch type furnace in which the solid fuel is charged before supply of the high temperature steam thereto, or a continuous feeding type of furnace in which the solid fuel is fed to the furnace simultaneously with supply of the high temperature steam thereto.

Preferably, the combustion means for reheating the combustion gas includes an injection portion for adding a part of the syngas and/or the combustion air to the cleaned combustion gas. The injection part is, e.g., a T-form connection of a combustion gas pipe or duct and a syngas or combustion air pipe or duct; or otherwise, a combustor for mixing the combustion gas with the syngas or the combustion air. Injection of the syngas or the combustion air causes re-combustion or secondary combustion of the combustion gas, so that the temperature of the combustion gas is raised. The injection of the syngas is preferably applied in a case where sufficient combustion air is supplied to the char combustion area (i.e., when substantially complete combustion of the char proceeds in the char combustion area and the combustion gas contains a relatively large quantity of oxygen). Re-combustion of the combustion gas is caused by addition of the syngas. On the other hand, injection of the combustion air into the injection portion is applied in a case where the amount of combustion air to the char combustion area is restricted (i.e., when incomplete combustion of the char proceeds in the char combustion area and the combustion gas contains a relatively large quantity of carbon monoxide and so forth). The combustion air is added to the combustion gas, and secondary combustion of the combustion gas is caused by injection of the combustion air, whereby the temperature of the combustion gas is raised and complete combustion of unburned combustible contents in the combustion gas is promoted. If desired, both of the syngas and the combustion air may be added to the combustion gas.

In a preferred embodiment of the present invention, the gasification system has a reformer, into which the pyrolysis gas of the pyrolysis area and the high temperature steam are introduced. The high temperature air or oxygen at a temperature equal to or higher than 600° C., preferably, equal to or higher than 900° C. is injected into a pyrolysis gas delivery passage or the reformer. The pyrolysis gas, the high temperature steam and the high temperature air (or oxygen) mix with each other in the reformer, and hydrocarbon (mainly tar component) in the pyrolysis gas is reformed to a reformed gas (syngas) containing hydrogen and carbon monoxide as its main components, by steam reforming reaction. Preferably, the reformed gas is purified by the successive purification step and is fed to the electric power generator, the hydrogen production apparatus or the like. A heat recovery device is preferably installed for cooling the reformed gas before purification, and water supplied to the heat recovery device is evaporated by sensible heat of the reformed gas. Steam thus obtained is fed to the steam heater, and is heated to be high temperature steam, as previously described. More preferably, a part of the purified gas is fed to the air heater, and air at a normal temperature is heated to the aforesaid high temperature air by heat of combustion of the purified gas.

In another embodiment of the present invention, the high temperature steam has a temperature equal to or higher than 900° C. Production of the tar in the pyrolysis area is minimized, and the aforementioned reforming step is omitted.

Preferably, a part of the purified gas or the pyrolysis gas is fed to the char combustion area as an auxiliary fuel. Heat of combustion of the purified gas or the pyrolysis gas compensates for shortage of heat of the char combustion. This enables adjustment of the temperature and/or the flow rate of the combustion gas of the char combustion area, so that the temperature and/or the flow rate of the high temperature steam fed to the pyrolysis area are controlled. Alternatively, the temperature of the char combustion area is raised so as to melt the ash of the char.

Preferred embodiments of the present invention are described in detail hereinafter, with reference to the accompanying drawings.

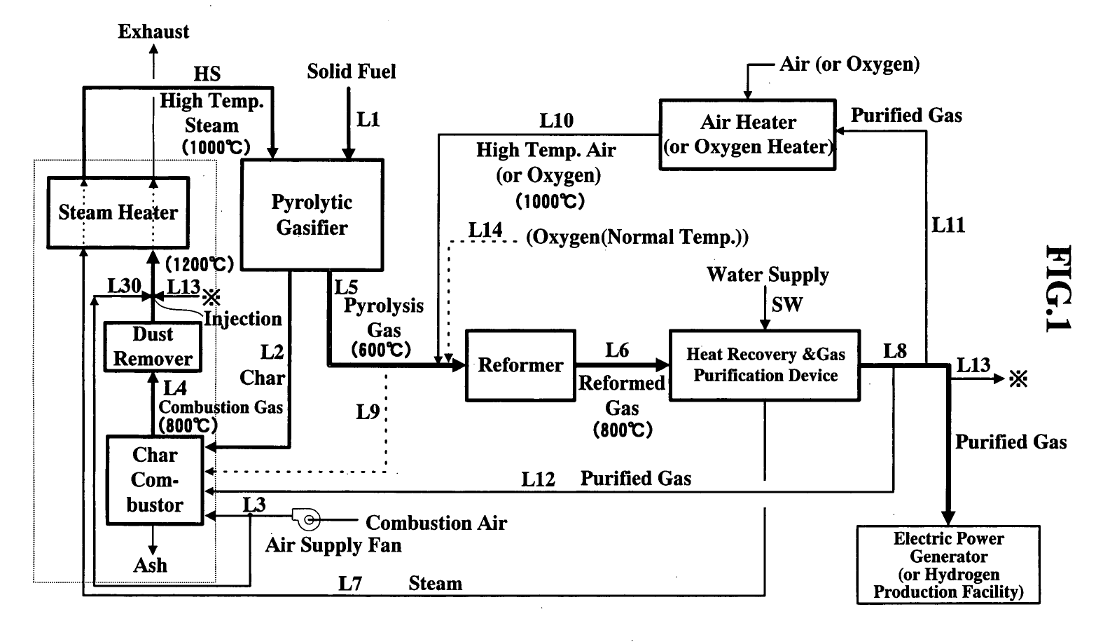

FIG. 1 is a block flow diagram showing the solid fuel gasification system which is the first embodiment of the present invention.

The solid fuel gasification system includes a pyrolytic gasifier which pyrolytically decomposes a solid fuel such as industrial waste, a steam heater which feeds high temperature steam at a temperature of approximately 1,000° C. to the gasifier, and a char combustor for combustion of char discharged from the gasifier. The steam heater is connected to the gasifier through a high temperature steam supply passage HS. A solid fuel supply passage L1 for feeding a solid fuel to the gasifier is connected to the gasifier, and a char feeding passage L2 for feeding char of the gasifier to the char combustor is connected to the gasifier. An air supply passage L3 is connected to the char combustor, and a combustion gas delivery passage L4 is connected to the steam heater through a high temperature dust remover. The dust remover provided on the passage L4 is, for example, a high temperature ceramic filter for cleaning combustion gas. A branch passage L30 of the air supply passage L3 is connected to the passage L4 between the dust remover and the steam heater.

The gasifier is connected to a reformer through a pyrolysis gas delivery passage L5, and the reformer is connected to a heat recovery and gas purification device through a reformed gas delivery passage L6. An in-furnace region of the gasifier is isolated from supply of air and oxygen, except for air and oxygen initially existing in the gasifier, or a small quantity of air and oxygen which may flow into the gasifier together with the supplied solid fuel. Therefore, the substantially only high temperature steam is fed to the in-furnace region of the gasifier. The pyrolysis gas of the gasifier is fed to the reformer through the passage L5 and the reformed gas of the reformer is fed to the heat recovery and gas purification device through the passage L6. If desired, a part of the pyrolysis gas is fed to the char combustor through a branch passage L9 shown by a dotted line.

A water supply line SW is connected to the heat recovery and gas purification device, and an upstream end of a steam supply passage L7 is also connected thereto. A downstream end of the passage L7 is connected to the steam heater. Steam produced by the heat recovered from the pyrolysis gas is fed to the steam heater through the passage L7. The heat recovery and gas purification device is connected to an electric power generator or a hydrogen production facility through a purified gas feeding passage L8, and purified gas effluent from the heat recovery and gas purification device is fed thereto as a fuel gas or a feedstock gas. A first branch passage L11 of the passage L8 is connected to an air heater, so that a part of the purified gas is fed to the air heater as a fuel for heating air. A high temperature air supply passage L10 of the air heater is connected to the pyrolysis gas delivery passage L5, and high temperature air at a temperature of approximately 1,000° C. is injected into the passage L5. A second branch passage L12 of the passage L8 is connected to the char combustor. If desired, a part of the purified gas is fed to the char combustor as an auxiliary fuel. A third branch passage L13 is further branched from the passage L8, and a downstream end of the passage L13 is connected to the combustion gas delivery passage L4 between the dust remover and the steam heater.

The solid fuel, such as industrial waste, is supplied to the pyrolytic gasifier and charged into the gasifier. An auxiliary fuel supply device (not shown), which is not included in the system, feeds a fuel for initial combustion to a burner assembly of the char combustor. An air supply fan provided on the air supply passage L3 feeds combustion air to the char combustor. If desired, an air preheater (not shown) is provided on the passage L3. In combustion operation of the char combustor, combustion gas at a temperature of approximately 800° C. is delivered from the char combustor to the combustion gas delivery passage L4. The combustion gas is fed to the steam heater through the dust remover and combustion means for reheating the combustion gas. An auxiliary fuel supply device (not shown), which is not included in the system, feeds a fuel for initial combustion to the combustion means.

Steam at a relatively low temperature (approximately 150˜300° C.) is initially fed to the steam heater from a process steam generator (not shown) which is not included in the system. The steam exchanges heat with the combustion gas effluent from the char combustor so that the steam is heated up to a high temperature of an approximately 1,000° C. This high temperature steam is fed to the gasifier by means of the high temperature steam supply passage HS.

The in-furnace region (pyrolysis area) of the gasifier is isolated from supply of air, and the only high temperature steam of the steam heater is fed to the gasifier. The temperature of the steam fed to the gasifier through the passage HS is set to be, e.g., 1,000° C. (outlet temperature of the passage HS). A furnace pressure of the gasifier is set to be atmospheric pressure (normal pressure), or 1-2 atmospheres. The solid fuel in the pyrolysis area is pyrolytically decomposed by the heat of the high-temperature steam introduced into the gasifier, so that pyrolysis gas having a temperature of approximately 600° C. is generated by pyrolytic decomposition of the solid fuel. The pyrolysis gas is produced in the pyrolysis area, substantially depending on the high temperature steam only, wherein the pyrolysis gas does not contain nitrogen but contains hydrogen and carbon monoxide as its main components. Further, the pyrolysis gas at a temperature of approximately 600° C. merely includes a relatively small quantity of tar component. The pyrolysis gas is delivered to the pyrolysis gas delivery passage L5, together with the high temperature steam of the gasifier.

An auxiliary fuel supply device (not shown), which is not included in the system, feeds a fuel for initial combustion to the air heater. The air heater heats air of an atmospheric temperature up to a temperature of approximately 1,000° C. by heat of combustion of the fuel, and the high temperature air is injected into the passage L5. This addition of the high temperature air compensates for shortage of heat for a reforming reaction in the following step (reforming step). It is preferable that a quantity of the additional air is minimized, so far as the heat required for the following step can be obtained.

The reformer is a hollow and non-catalytic reactor vessel. The pyrolysis gas, high temperature air and high temperature steam flow through the passage L5 into an inside region of the reformer and mix with each other, whereby a steam reforming reaction (endothermic reaction) of hydrocarbon (mainly, tar component) contained in the pyrolysis gas is caused in this mixing process. The pyrolysis gas is reformed to be a high calorie gas containing a relatively large quantity of hydrogen and carbon monoxide. In the reforming area, an exothermic reaction between the high temperature air and the pyrolysis gas simultaneously proceeds, and therefore, the reformed gas (syngas) at a temperature of approximately 800° C. is delivered to the reformed gas delivery passage L6.

The reformed gas contains a small quantity of steam and a small quantity of nitrogen supplied to the system by addition of the high temperature air. Alternatively, an oxygen heater may be employed for preventing such inclusion of nitrogen, instead of the aforementioned air heater. In such a case, oxygen preheated by the oxygen heater is added to the pyrolysis gas through the passage L10. As a modification, oxygen at an atmospheric temperature (normal temperature) may be directly added to the pyrolysis gas by the passage L14 (shown by a dotted line).

The reformed gas (syngas) of the reformed gas delivery passage L6 is introduced into the heat recovery and gas purification device, which has a heat recovery section for producing steam by heat exchange between the reformed gas and the supplied water, and a purifying section (scrubber or the like) for purifying the reformed gas after the heat recovery. The reformed gas having a high temperature of approximately 800° C. is cooled by heat exchange with the water, whereas the water evaporates to be steam which is delivered to the steam supply passage L7. The reformed gas passes through the purifying section which removes the steam, solid contents and so forth from the gas. The reformed gas is fed to a gas turbine or the like constituting the electric power generator as a fuel gas, or fed to a hydrogen production facility as a feedstock gas, by means of the purified gas feeding passage L8.

A part of the purified gas is fed through the first branch passage L11 to the air heater, which is, e.g., an air heater disclosed in JP 2002-158885. The air heater heats the air from an atmospheric temperature up to a temperature of approximately 1,000° C. by heat of combustion of the purified gas and delivers the heated air to the high temperature air supply passage L10. If desired, a part of the purified gas is delivered through the second branch passage L12 to the char combustor as an auxiliary fuel.

A part of the purified gas or a part of combustion air of the passage L3 is injected from the branch passage L13 or L30 into the combustion gas delivery passage L4 between the dust remover and the steam heater. Both of the purified gas and the combustion air may be injected into the passage L4. Injection part for the gas or air is formed by T-form connection of pipes or ducts, or a combustor provided on the passage L4.

The temperature of the combustion gas to be fed to the dust remover is regulated to be approximately 600-800° C. by control of combustion in the char combustor. However, re-combustion or secondary combustion of the combustion gas is caused by addition of the purified gas (L13) and/or the combustion air (L30), so that the temperature of the combustion gas is raised. Therefore, the combustion gas to be introduced into the steam heater has a temperature exceeding 1,000° C., e.g., a temperature of approximately 1,200° C.

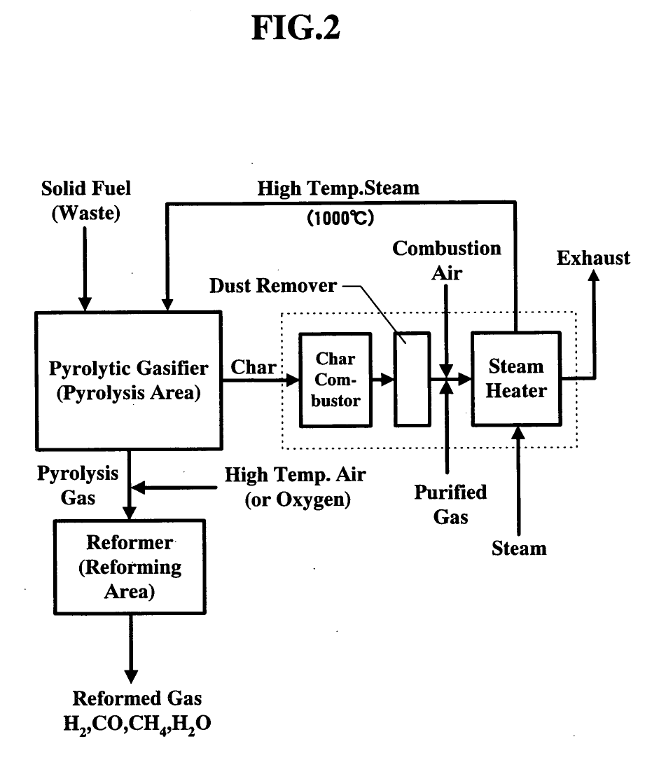

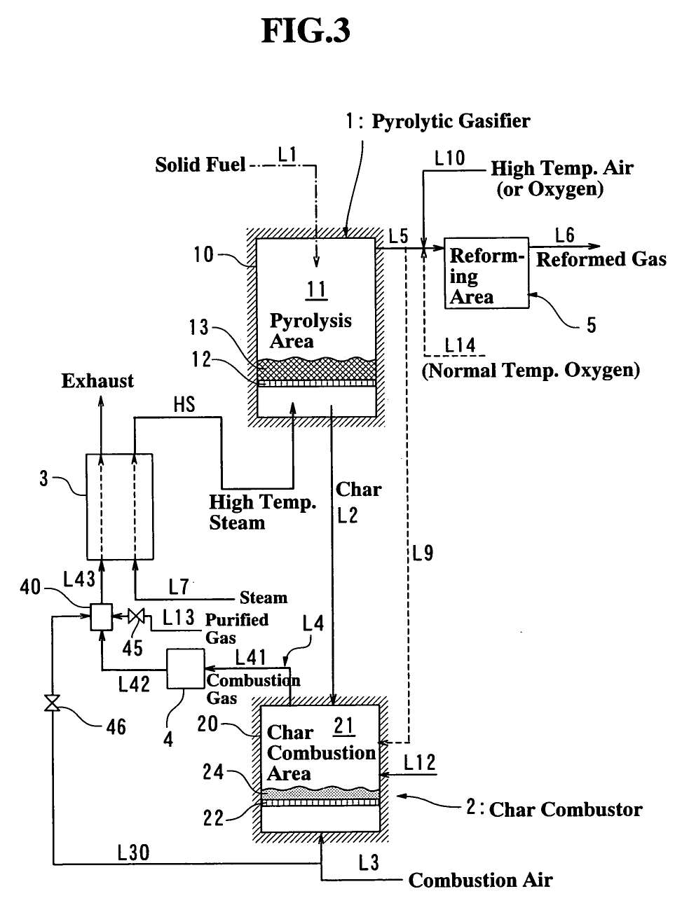

FIGS. 2 and 3 are a block flow diagram and a system schematic diagram showing an arrangement of a heat source section of the gasification system in this embodiment.

When the pyrolytic gasification reaction in the gasifier is stabilized, supply of the auxiliary fuel and the steam from the equipment out of the system is stopped. The gasification system shifts to a regular operation mode, wherein the char of the gasifier is used as the thermal energy source for heating the steam. As shown in FIG. 1, the air (or oxygen) used for reforming of the pyrolysis gas is heated by heat of combustion of the purified gas, and the water exchanges heat with the reformed gas to produce the steam to be fed to the steam heater. Therefore, in the regular operation mode, the thermal energy for heating the steam and the air (or oxygen) and for producing the steam can be obtained by the char and the pyrolysis gas produced in the gasifier 1. That is, operation of the gasification system is kept by the char and the pyrolysis gas of the gasifier 1 acting as the thermal energy sources.

As shown in FIG. 3, the gasifier 1 is provided with a furnace body 10 defining the pyrolysis area 11. A furnace bed 12 with a large number of vent holes is provided in a bottom part of the body 10. A fixed type of furnace bed made of ceramic with a large number of vent holes is preferably used as the bed 12. The high temperature steam supply passage HS and the char feeding passage L2 are connected to the furnace bottom part. The solid fuel is fed to the pyrolysis area 11 through the solid fuel supply passage L1 and disposed on the bed 12. The gasifier 1 is a fixed bed type of furnace in which the high temperature steam is fed from the furnace bottom part. The pyrolysis area 11 is closed, except for openings of the passage L1 and the pyrolysis gas delivery passage L5 positioned in a top part of the furnace body. Therefore, ambient air is substantially completely prevented from entering the pyrolysis area 11.

The high temperature steam of the steam heater 3 blows upward from the furnace bottom part into the furnace. The steam passes through the vent holes of the bed 12 to be in contact with the solid fuel 13 for heating the fuel 13. In the pyrolysis area 11 isolated from supply of steam, the fuel 13 is pyrolytically decomposed only by supply of the steam, so that the pyrolysis gas is generated. Preferably, the temperature of steam is set to be a temperature equal to or higher than 1,000° C. in order to accelerate the rate of pyrolytic decomposition reaction. The pyrolysis gas and the steam are fed to the reformer 5 through the pyrolysis gas delivery passage L5 connected to the top part of the furnace body. The high temperature air (or oxygen) of the high temperature air supply passage L10 is added to the pyrolysis gas and the steam in the passage L5. As shown by a dotted line, oxygen at an atmospheric temperature may be supplied to the passage L5 from the passage L14.

The pyrolysis gas, steam and air (or oxygen) are introduced into the reformer 5 to be mixed with each other therein, and hydrocarbon contained in the gas (mainly, tar component) is reformed. Therefore, the reformed gas (syngas) containing a relatively large quantity of hydrogen and carbon monoxide is delivered through the reformed gas delivery passage L6 to the heat recovery and gas purification device (FIG. 1). For example, a reformer with construction as disclosed in JP2002-210444 is preferably employed as the reformer 5.

The char produced by pyrolytic decomposition of the solid fuel 13 flows down through the vent holes of the bed 12, and is fed from a char discharge port of the furnace bed zone to the char combustor 2 through the char feeding passage L2. The char combustor 2 has a construction similar to that of the gasifier 1. That is, the char combustor 2 has a furnace body 20 defining a char combustion area 21 and a furnace bed 22 having a large number of vent holes. A ceramic fixed bed with a large number of perforated vent holes is preferably used as the bed 22. The air supply passage L3 is connected to a bottom part of the combustor 2, and the combustion gas delivery passage L4 is connected to a top part of the combustor 2.

The char fed to the char combustor 2 is accumulated on the bed 22, and the combustion air of the passage L3 blows upward through the holes of the bed 22 into the char combustion area 21. The furnace temperature of the combustor 2 reaches a temperature exceeding 800° C. The combustion gas at a temperature of approximately 600-800° C. is delivered to a fluid passage L41 of the passage L4. If desired, the purified gas of the second branch passage L12 or the pyrolysis gas of the branch passage L9 (shown by a dotted line) is additionally fed to the char combustion area 11.

The combustion gas passes through the dust remover 4, and the dust or the like in the combustion gas is removed. The combustion gas is delivered to the fluid passage L42 from the remover 4. The injection part 40 is a T-form connection of the passages L13, L30 with the passage L42, or a combustor connected with the passage L13, L30. The combustion gas mixes with the purified gas and/or the combustion air at the injection part 40 to take a re-combustion or secondary combustion reaction.

The passages L13, L30 are provided with control valves 45, 46 for controlling supply of the purified gas and the combustion air to the injection part 40. The control valves 45, 46 control the flow rates of the purified gas and the combustion air so that the re-combustion or secondary combustion of the combustion gas suitably proceeds in the injection part 40. For instance, when complete combustion of the char is caused in the char combustion area 21, the combustion gas contains a relatively large quantity of oxygen. Therefore, the valves 45, 46 mainly feed the purified gas of the passage L13 to the injection part 40. On the other hand, incomplete combustion of the char is caused in the area 21, the combustion gas contains a relatively large quantity of carbon monoxide, and therefore, the valves 45, 46 mainly feed the combustion air of the passage L30 to the injection part 40.

The combustion gas is heated up to a high temperature exceeding 1,000° C., owing to the re-combustion or secondary combustion at the injection part 40, and then, the heated gas is fed to the steam heater 3 through the fluid passage L43. The combustion gas exchanges heat with the steam to heat the steam to a high temperature, as previously described, and the gas is cooled. The cooled combustion gas is exhausted to the atmosphere through an exhaust passage.

The steam heater 3, which is, e.g., a Ljungstrom type heat-exchanger having a high temperature efficiency, heats the steam of the steam supply passage L7 up to a temperature of approximately 1,000° C. and delivers the steam to the high temperature steam supply passage HS. As the steam heater 3, a regenerator type heat-exchanger with a regenerator having a ceramic honey-comb structure or the like, or a recuperator type heat-exchanger with a heat transfer coil may be adopted. In such a case, the steam of the passage L7 is heated with heat exchange action taken between the steam and the combustion gas by means of the regenerator, or heat exchange between the combustion gas and the steam flowing through the coil.

If the amount of combustion of the char in the combustor 2 is insufficient, a part of the pyrolysis gas or the purified gas is additionally fed to the burner assembly (not shown) of the combustor 2 through the passage L9, L12.

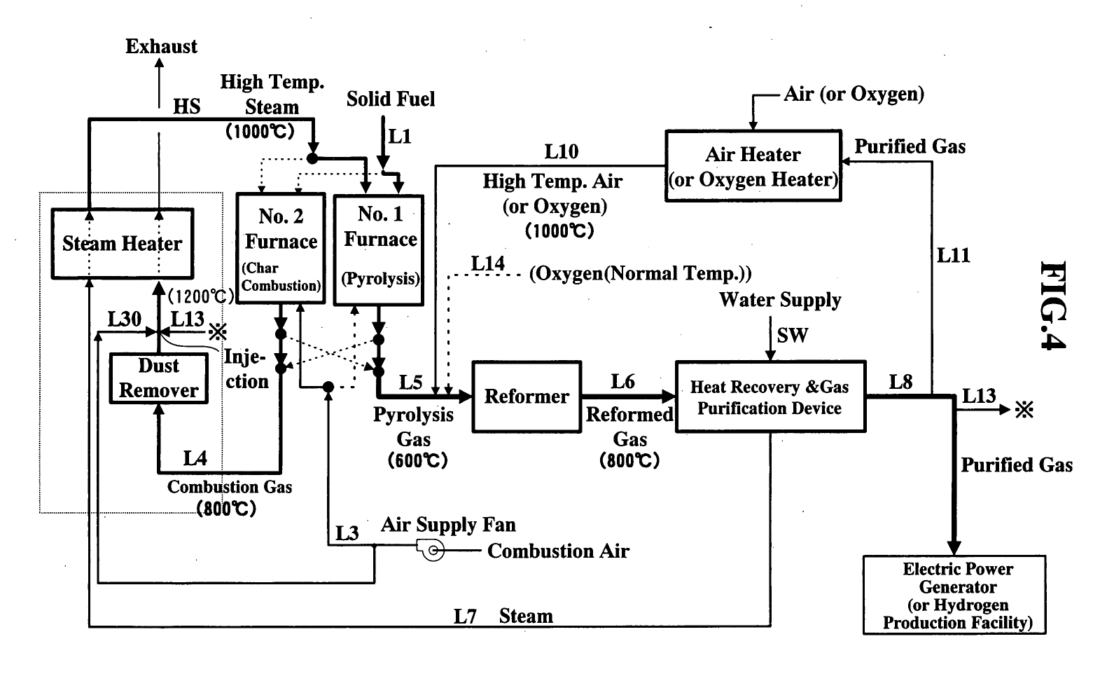

FIGS. 4 to 7 are block flow diagrams and system schematic diagrams showing an arrangement of the second embodiment of the solid fuel gasification system according to the present invention.

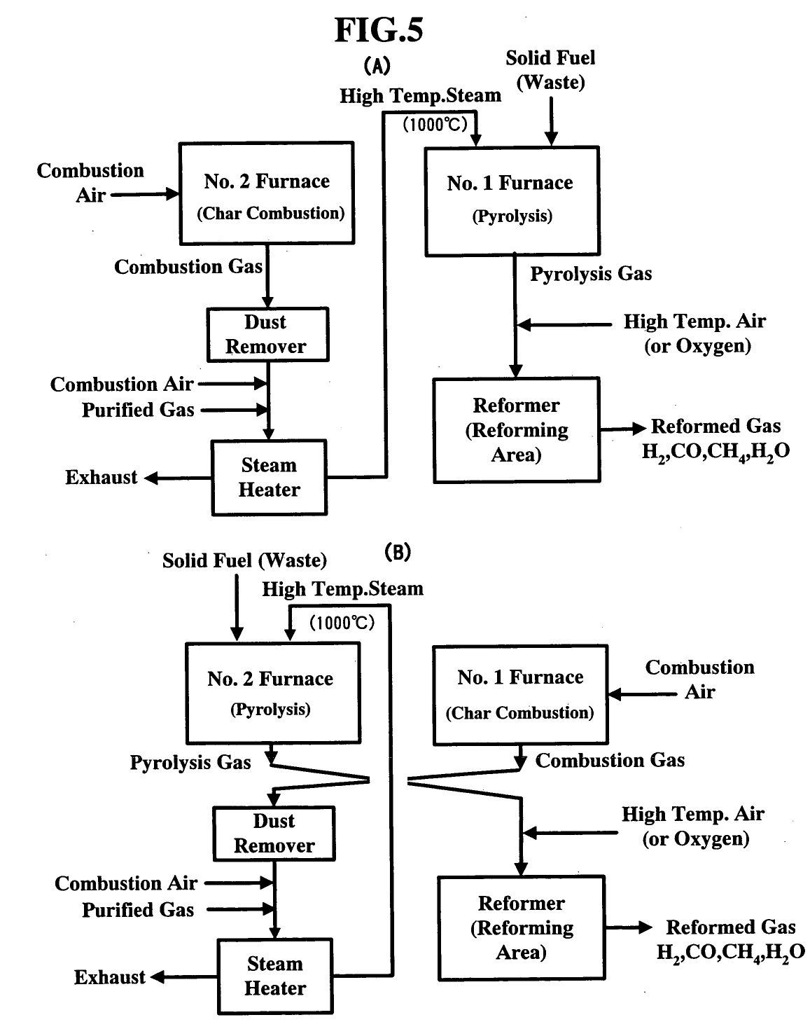

In the aforementioned first embodiment, the gasification system is provided with the char combustor connected with the gasifier in series. However, the system of the second embodiment is provided with first and second furnaces in parallel, as illustrated in FIGS. 4 and 5. Each of the furnaces functions as the gasifier and the char combustor.

In FIG. 5, the first and second steps of the system are illustrated respectively, which are carried out alternately. In the first step as shown in FIG. 5(A), the first furnace performs a gasifying operation and the second furnace performs a char combustion operation. On the other hand, in the second step as shown in FIG. 5(B), the first furnace performs the char combustion operation and the second furnace performs the gasifying operation.

In the first step (FIG. 5(A)), the high temperature steam is fed to the first furnace. The pyrolysis gas produced by the gasifying operation of the first furnace is fed to the reformer. The solid fuel is charged in the first furnace beforehand, or continuously fed to the first furnace simultaneously with feeding of the high temperature steam.

When the gasifying operation of the first furnace (FIG. 5(A)) is finished, the second step (FIG. 5(B)) is carried out wherein the combustion air is fed to the first furnace. In the second step, the char residue deposited on the furnace bed portion of the first furnace in its gasifying operation (FIG. 5(A)) makes a combustion reaction by supply of the combustion air, so that the first furnace is operated as the char combustor to deliver combustion gas to the dust remover. The combustion air and/or the purified gas are added to the combustion gas cleaned by the remover, as in the first embodiment, whereby re-combustion or secondary combustion of the combustion gas is caused to raise its temperature, so that the high temperature combustion gas is fed to the steam heater. The steam fed to the steam heater exchanges heat with the high temperature combustion gas, so that the steam is heated up to a temperature of approximately 1,000° C. The high temperature steam thus heated is fed to the second furnace, which pyrolyzes the solid fuel by feed of the high temperature steam and which feeds pyrolysis gas to a reformer. The solid fuel is charged to the second furnace beforehand, or continuously fed thereto simultaneously with supply of the high temperature steam.

When the gasifying operation of the second furnace is finished, the first step (FIG. 5(A)) is carried out wherein the char residue deposited on the furnace bed portion of the second furnace in its gasifying operation (FIG. 5(B)) takes a combustion reaction, so that the second furnace is operated as the char combustor to deliver its high temperature combustion gas to the dust remover. The combustion air and/or the purified gas are added to the combustion gas cleaned by the remover, whereby re-combustion or secondary combustion of the combustion gas is caused and the heated combustion gas is fed to the steam heater. The steam fed to the steam heater is heated up to a temperature of approximately 1,000° C. by heat exchange with the high temperature combustion gas, and thereafter, fed to the first furnace, which pyrolyzes the solid fuel by supply of the high temperature steam and which feeds the pyrolysis gas to the reformer.

The first and second steps (FIGS. 5(A) and 5(B)) are alternately carried out at an interval of time set to be a few hours, or ten or more hours, so that the first and second furnaces are alternately operated as the gasifier or the char combustor. That is, each of the first and second furnaces alternately acts as both the gasifier producing the pyrolysis gas and the char combustor producing the high temperature combustion gas by combustion of the residual char on the furnace bed portion.

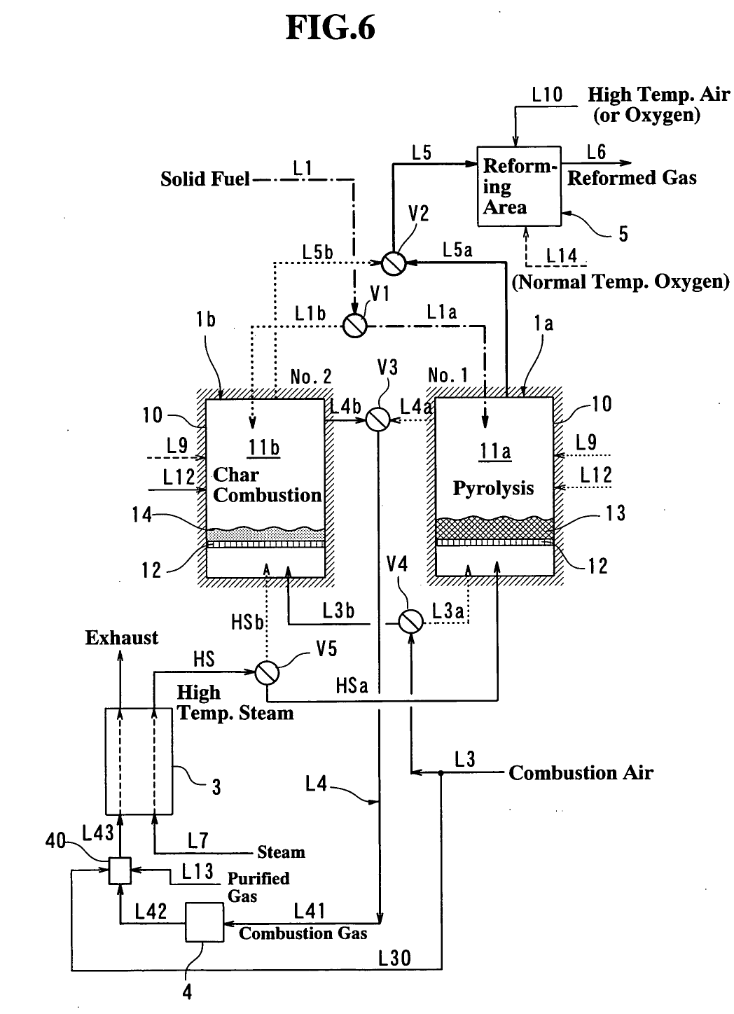

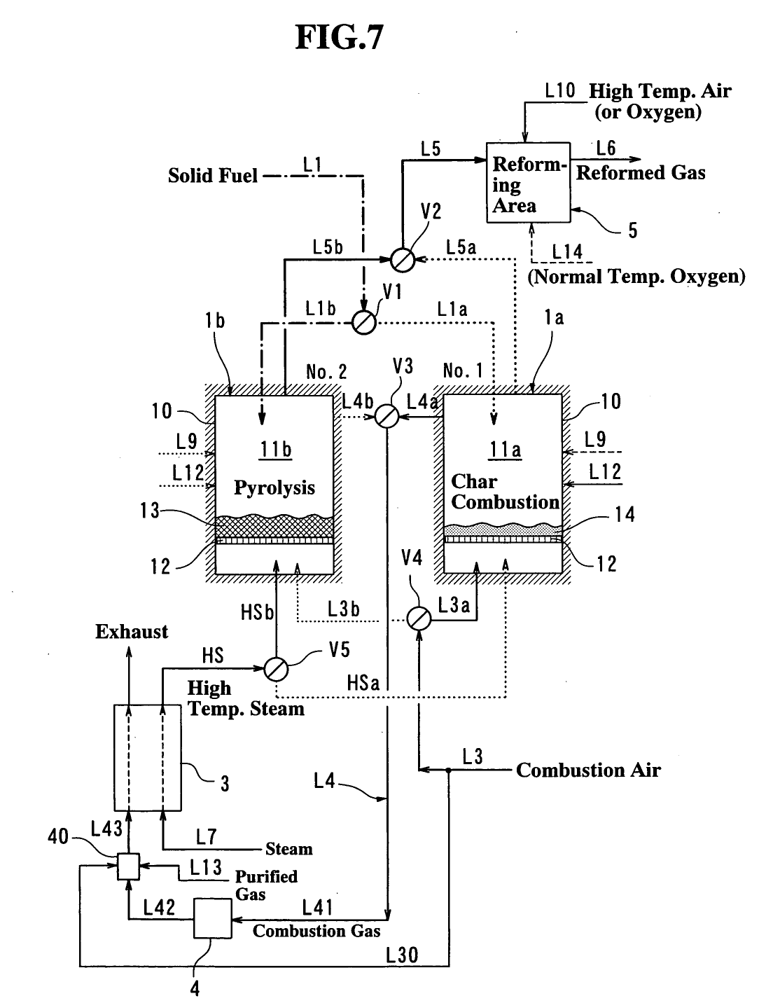

FIGS. 6 and 7 are system schematic diagrams showing the arrangement of the heat source section of the gasification system. In FIG. 6, the first step of the system is illustrated. In FIG. 7, the second step of the system is illustrated.

Each of the first and second furnaces 1a, 1b has substantially the same construction as that of the gasifier of the first embodiment, wherein the furnace body 10 is provided at its lower portion with the furnace bed 12 having a large number of vent holes. The solid fuel supply passages L1a, L1b, the pyrolysis gas feeding passages L5a, L5b, and the combustion gas delivery passages L4a, L4b are connected to upper portions of the furnace bodies respectively. The passages L1a, L1b are connected with the solid fuel supply passage L1 by means of a change-over valve V1. The passages L4a, L4b are connected with the combustion gas delivery passage L4 by means of a change-over valve V3.

The air supply passages L3a, L3b and the high temperature steam supply passages HSa, HSb are connected to furnace bottom portions of the first and second furnaces 1a, 1b respectively. The passages L3a, L3b are connected with the air supply passage L3 by means of a change-over valve V4. The passages HSa, HSb are connected with the high temperature steam supply passage HS by means of a change-over valve V5.

Each of the valves V1-V5 takes its first position in the first step (FIG. 6), in which the passages L1, L5, HS are connected to the first furnace la and the passages L3, L4 are connected to the second furnace 1b. The first furnace la functions as the pyrolytic gasifier which supplies the reformer 5 with the pyrolysis gas produced by pyrolytic decomposition of the solid fuel 13. The second furnace 1b functions as the char combustor which supplies the steam heater 3 with the combustion gas produced by the combustion reaction of the char 14 on the furnace bed portion.

Each of the valves V1-V5 takes its second position in the second step (FIG. 7), in which the passages L1, L5, HS are connected to the second furnace lb and the passages L3, L4 are connected to the first furnace 1a. The second furnace lb functions as the pyrolytic gasifier which supplies the reformer 5 with the pyrolysis gas produced by pyrolytic decomposition of the solid fuel 13. The first furnace la functions as the char combustor which supplies the steam heater 3 with the combustion gas produced by the combustion reaction of the char 14 on the furnace bed portion.

If desired, a part of the purified gas of the purified gas delivery passage L8 may be additionally fed to the first or second furnace in the char combustion operation through the second branch passage L12. Further, a part of the pyrolysis gas of the passage L5 may be additionally fed thereto through the branch passage L9.

According to such an embodiment, the high temperature combustion gas for heating the steam can be produced in the char combustion operation of the first or second furnace 1a, 1b by combustion of the residual char deposited on the bottom portion of the furnace 1a, lb in the gasifying operation, without transfer of the char to the char combustor. Therefore, it is unnecessary to provide a char combustor particular to combustion of the char, and it is possible to omit provision of the char delivery passage L2 (FIG. 2) for transferring the char from the furnace 1 to the char combustor.

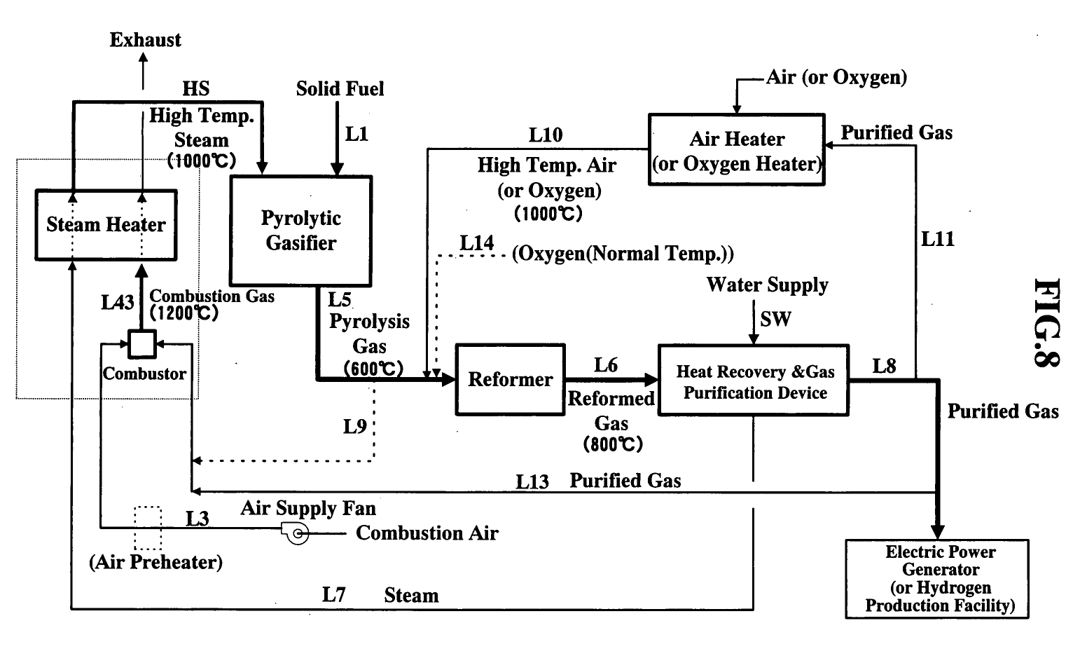

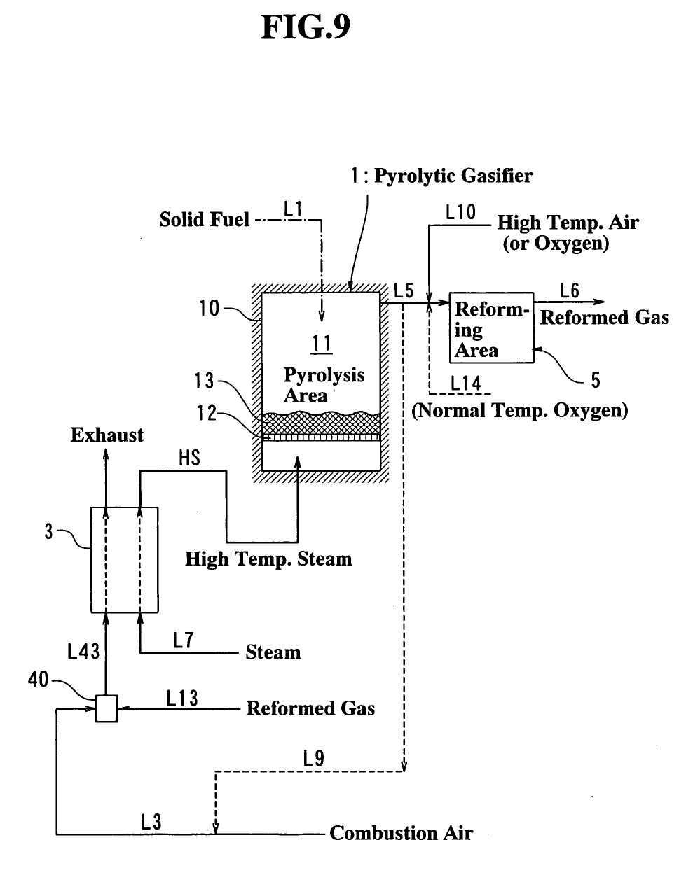

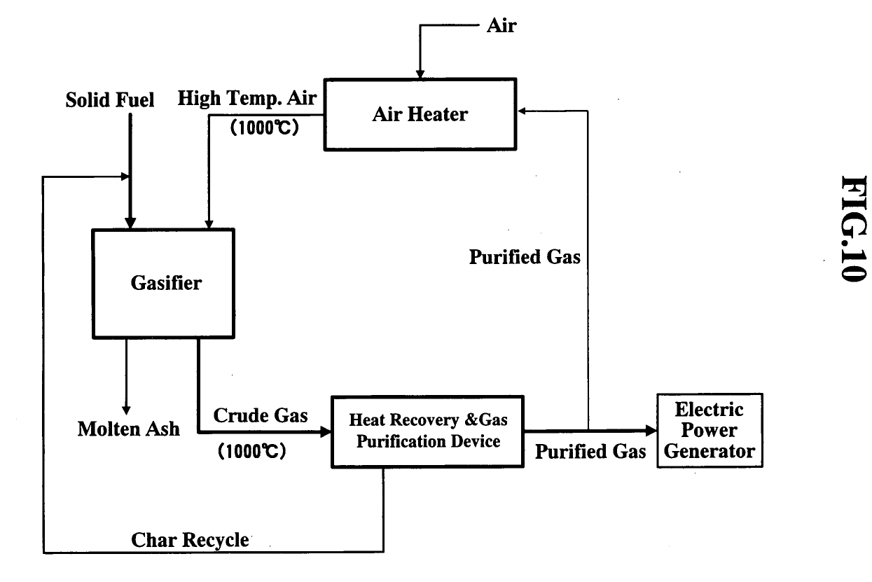

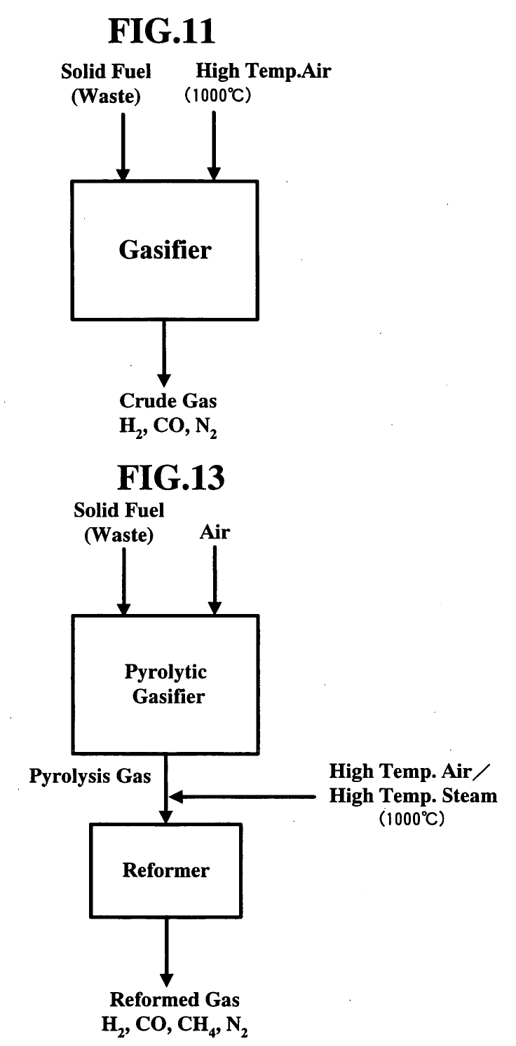

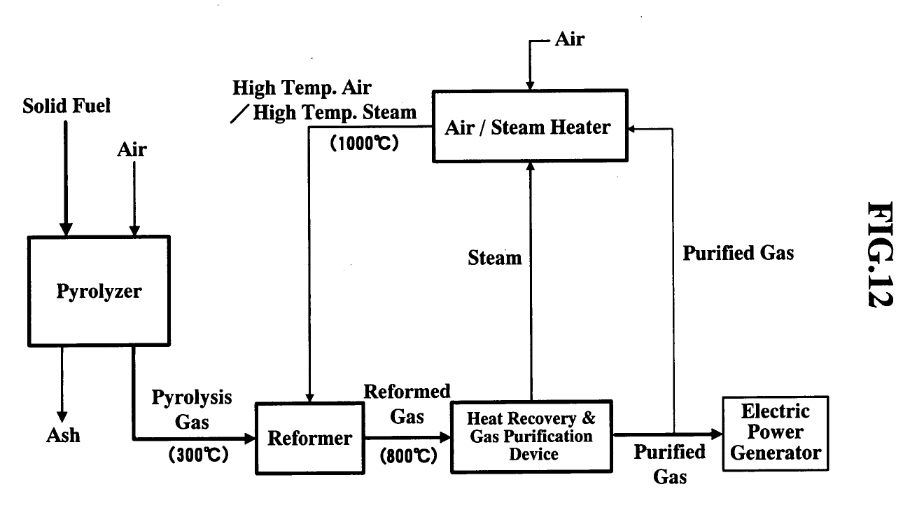

FIGS. 8 and 9 are a block flow diagram and a system schematic diagram generally showing an arrangement of the gasification system, which is the third embodiment of the present invention.

In the aforementioned first and second embodiments, the system has the char combustion area, the dust remover and the combustion means for re-heating the combustion gas. However, the system of this embodiment has a combustor 40 for producing the high temperature combustion gas with the combustion reaction of the purified gas and the air. The combustion air and the purified gas are introduced into the combustor 40 through the air supply passage L3 and the branch passage L13. If desired, the combustion air is preheated by an air preheater (shown by dotted lines). The combustion gas at a temperature above 1,000° C. is fed from the combustor 40 to the steam heater 3 through the fluid passage L43. As previously described, the combustion gas exchanges heat with the steam, and the cooled gas is exhausted to the atmosphere through the exhaust passage. The steam is heated up to a temperature of approximately 1,000° C. by heat exchange with the high temperature combustion gas and is fed to the gasifier 1. The high temperature steam fed to the gasifier 1 pyrolyzes the solid fuel, and the gasifier 1 feeds the pyrolysis gas to the reformer 5. A part of the pyrolysis gas of the pyrolysis gas delivery passage L5 may be fed to the combustor 40 through the branch passage 9 (FIG. 9). Since the other arrangements of the system are substantially the same as those of the first and second embodiments, further detailed explanation thereon is omitted.

This embodiment is preferably applied to a gasification system with use of the solid fuel such as a biomass fuel, which produces little char residue. Since the combustion gas is produced by combustion reaction between the purified gas and the air, the combustion gas can be fed to the steam heater 3 without cleaning the gas by the cleaning device (therefore, without restriction of temperature). Thus, the high temperature combustion gas of the temperature above 1,000° C. can be directly introduced into the steam heater 3. Further, it is possible to introduce a part of the pyrolysis gas (L9) into the combustor 40 in order to produce the aforementioned high temperature combustion gas by combustion of the pyrolysis gas.

As a modification, the system provided with the first and second furnaces as in the second embodiment may be so arranged that the pyrolysis gas or its purified gas of the first or second furnaces is fed to the combustor 40 selectively from one of the first and second furnaces. In such a case, the arrangement of the heat source section of the system is, for instance, the same as that of the system as shown in FIGS. 4-8 but different therefrom in that the fluid passages L4a, L4b, L41, L42, the valve V3 and the dust remover 4 are omitted from the system, and that the pyrolysis gas or its purified gas is fed to the combustor 40 alternately from either one of the first and second furnaces.

Although one preferred embodiment of the present invention has been described in detail, the present invention is not limited thereto, but may be modified or changed without departing from the scope of the invention defined in the accompanying claims.

For example, production of the tar component can be minimized by feeding the high temperature steam equal to or higher than 1,000° C. to the pyrolytic gasifier. This allows the reforming step of the reformer to be omitted. Further, the solid fuel to be charged in the pyrolysis area may be crushed in a pretreatment step such as a crushing treatment. Furthermore, it is possible to melt the ash by raising the furnace temperature of the char combustor, although the ash of the combustor is discharged from the combustor in the aforementioned first embodiment. Further, the system of the aforementioned second embodiment has the first and second furnaces alternately carrying out the gasification and char combustion, but three or more furnaces may be provided in the system so as to be changed over.

### INDUSTRIAL APPLICABILITY

The present invention is preferably applied to a gasification system of a low quality solid fuel, such as waste. The gasification system according to the present invention can produce a syngas which contains hydrogen and carbon monoxide as its main components and which has a high calorific value, and can feed the syngas to an electric power generator, a hydrogen production facility and so forth.

1. A solid fuel gasification system pyrolyzing a solid fuel to produce a syngas containing hydrogen and carbon monoxide as its main components, comprising:
a pyrolysis area isolated from supply of air;
a char combustion area producing a combustion gas by combustion of char of said pyrolysis area in existence of combustion air;
a steam heater heating steam by heat exchange between the combustion gas and the steam;
a dust remover which cleans the combustion gas of the char combustion area between the char combustion area and said steam heater; and
combustion means for reheating the combustion gas, which causes combustion of the cleaned combustion gas delivered from the dust remover to the steam heater for raising temperature of the cleaned combustion gas,
wherein said steam heater is provided with a heat-exchanger, which heats said steam to be high temperature steam having a temperature equal to or higher than 600° C. by means of the heat exchange between the combustion gas and the steam, and wherein the high temperature steam thus heated is fed to said pyrolysis area to cause pyrolytic decomposition of the solid fuel in the pyrolysis area in order to produce the pyrolysis gas therein.

2. A solid fuel gasification system pyrolyzing a solid fuel which produces little char residue after pyrolytic decomposition, and producing a syngas which contains hydrogen and carbon monoxide as its main components, comprising:
a pyrolysis area isolated from supply of air;
a combustion means for generating a combustion gas having a temperature exceeding 1,000° C. by combustion of the pyrolysis gas which is produced by the pyrolytic decomposition of the solid fuel in the pyrolysis area, or combustion of a purified gas which is obtained from reforming of said pyrolysis gas; and
a steam heater heating steam by heat exchange between said combustion gas and the steam;
wherein said steam heater is provided with a heat-exchanger which heats said steam into high temperature steam having a temperature equal to or higher than 600° C. by means of the heat exchange between the combustion gas and the steam, and wherein the high temperature steam is fed to said pyrolysis area to cause pyrolytic decomposition of the solid fuel in the pyrolysis area in order to produce the pyrolysis gas therein.

3. The system as defined in claim 1, wherein said combustion means has an injection portion for adding a part of the syngas and/or the combustion air to the cleaned combustion gas, and injection of the syngas and/or the combustion air causes re-combustion or secondary combustion of the combustion gas, so that the temperature of the combustion gas is raised.

4. The system as defined in claim 1, wherein said char combustion area is provided within a char combustor, into which the char of said pyrolysis area is introduced, and combustion air for incineration of the char is fed to the char combustion area.

5. The system as defined in claim 1, comprising first and second furnaces, each of which has an in-furnace area acting both as a pyrolysis area and a combustion area of the char, and a change-over means for switching operation of the furnaces, wherein the change-over means are alternately changed over to either the first or the second positions, the first position being a position for feeding the high temperature steam to the first furnace and feeding the combustion air to the second furnace, and the second position being a position for feeding the combustion air to the first furnace and feeding the high temperature steam to the second furnace.

6. The system as defined in claim 1, wherein a part of the pyrolysis gas or a part of purified gas obtained from purification of the pyrolysis gas is fed to the char combustion area as an auxiliary fuel for compensation of heat of combustion in the char combustion area.

7. The system as defined in claim 6, further comprising control means for adjusting the temperature and/or the flow rate of the combustion gas of the char combustion area, so that the temperature and/or the flow rate of the high temperature steam to be fed to the pyrolysis area are controlled.

8. The system as defined in claim 1, further comprising a reformer which is in communication with the pyrolysis area through a pyrolysis gas delivery passage, and an air heater for heating air to be high temperature air having a temperature equal to or higher than 600° C. by means of heat of combustion of said syngas, wherein the high temperature air is injected into the pyrolysis gas delivery passage or the reformer.

9. The system as defined in claim 1, further comprising a reformer which is in communication with said pyrolysis area through a pyrolysis gas delivery passage, wherein oxygen is injected into the pyrolysis gas delivery passage or the reformer.

10. The system as defined in claim 1, wherein a heat recovery and gas purification device is provided, which is in communication with said pyrolysis area, and said heat-exchanger heats the steam up to a temperature equal to or higher than 900° C.; and wherein the pyrolysis gas of the pyrolysis area is directly fed to the heat recovery and gas purification device from the pyrolysis area.

11. The system as defined in claim 1, wherein a pyrolyzer defining said pyrolysis area is provided, which blows said high temperature steam upward from its furnace bottom part to the solid fuel deposited on its furnace bed so that the solid fuel is heated to produce the pyrolysis gas in the pyrolysis area isolated from supply of air.

12. The system as defined in claim 11, wherein said furnace bed is a fixed bed with a large number of vent holes, means for supplying the solid fuel is provided in an upper part of said pyrolysis area, and a supply passage of said high temperature steam is connected to said furnace bottom part located below said furnace bed; and wherein said high temperature steam passes through the vent holes of the furnace bed to be in contact with the solid fuel, so that the solid fuel is heated to produce the pyrolysis gas.

13. The system as defined in claim 1, wherein a pyrolyzer defining said pyrolysis area is provided, which blows said high temperature steam upward from its furnace bottom part to the solid fuel deposited on its furnace bed so that the solid fuel is heated to produce the pyrolysis gas in the pyrolysis area isolated from supply of air; and wherein a char feeding passage for feeding the char to said char combustion area is connected to the furnace bottom part.

14. The system as defined in claim 13, wherein said furnace bed is a fixed bed with a large number of vent holes, means for supplying the solid fuel is provided in an upper part of said pyrolysis area, and a supply passage of said high temperature steam is connected to said furnace bottom part located below the furnace bed; and wherein the high temperature steam passes through the vent holes of the furnace bed in order to be in contact with the solid fuel so that the solid fuel is heated.

15. The system as defined in claim 2, further comprising a reformer which is in communication with the pyrolysis area through a pyrolysis gas delivery passage, and an air heater for heating air to be high temperature air having a temperature equal to or higher than 600° C. by means of heat of combustion of said syngas, wherein the high temperature air is injected into the pyrolysis gas delivery passage or the reformer.

16. The system as defined in claim 2, further comprising a reformer which is in communication with said pyrolysis area through a pyrolysis gas delivery passage, wherein oxygen is injected into the pyrolysis gas delivery passage or the reformer.

17. The system as defined in claim 2, wherein a heat recovery and gas purification device is provided, which is in communication with said pyrolysis area, and said heat-exchanger heats the steam up to a temperature equal to or higher than 900° C.; and wherein the pyrolysis gas of the pyrolysis area is directly fed to the heat recovery and gas purification device from the pyrolysis area.

18. system as defined in claim 2, wherein a pyrolyzer defining said pyrolysis area is provided, which blows said high temperature steam upward from its furnace bottom part to the solid fuel deposited on its furnace bed so that the solid fuel is heated to produce the pyrolysis gas in the pyrolysis area isolated from supply of air.
